(19) United States
(12) Patent Application Publication
(10) Pub. No.: US 2018/0305520 A1
(43) Pub. Date: Oct. 25, 2018

(54) HIGH CONTENT FAR-INFRARED ELASTOMER AND METHOD OF MANUFACTURING THE SAME

(71) Applicant: JOY IN BIOTECHNOLOGY CO., LTD., Taichung (TW)

(72) Inventor: Sheng-Hsien Yang, Taichung (TW)

(21) Appl. No.: 15/490,918

(22) Filed: Apr. 19, 2017

(51) Int. Cl. C08K 3/36; C08K 3/34; C08K 3/28; C08K 3/22; C08K 11/00; C08L 21/00; B32B 25/10

(52) U.S. Cl. CPC C08K 3/36; C08K 3/34; C08K 3/28; C08K 3/22; C08K 11/00; C08L 21/00; B32B 2264/10; C08K 2003/2227; C08K 2003/2237; C08K 2003/222; C08L 2205/025; C08K 2201/001; B32B 25/10

(57) ABSTRACT

The present invention discloses a high content far-infrared elastomer and the method for manufacturing the far-infrared elastomer. The far-infrared elastomer includes an elastic material and a far-infrared material, wherein the elastic material has a weight proportion of 10-34.9%, the far-infrared material has a weight proportion of 65.1-90%, and the far-infrared elastomer has a specific weight of 1.5-4.0 and a hardness of 40-90 degrees. Therefore, the content of the far-infrared powder in the carrier has the optimum coverage, to enhance the irradiance of the far-infrared rays.

### BACKGROUND OF THE INVENTION

### 1. Field of the Invention

The present invention relates to a high content far-infrared elastomer and the method for manufacturing the same.

### 2. Description of the Related Art

The far-infrared material is formed by metallic oxidants, such as silicon oxide, alumina and calcium oxide and the like, which are mixed and worked. A carrier is used to carry the far-infrared powder so that the far-infrared material is available for a health product. The carrier includes ceramics, plastics, rubber, fiber or glue. The carrier and the far-infrared powder are mixed to form a far-infrared product whose radiation effect depends on the content of the far-infrared powder. The far-infrared powder having a high content enhances the irradiance to achieve the far-infrared effect. The far-infrared powder of the conventional far-infrared product has a high emissivity but has a low content, so that the irradiance of the far-infrared rays is not great enough and cannot achieve the far-infrared effect.

It is found from the research that, the content of the far-infrared powder in the carrier is limited. For example, the content of the far-infrared powder in the ceramic carrier is about 35%, in the rubber carrier is about 30%, in the fiber carrier is about 5%, and in the glue carrier is about 50%, Besides, the ceramic carrier is limited by the factors of shaping, hardness and burning temperature, the rubber carrier is limited by the factors of vulcanization and interconnection density, the plastic carrier is limited by the factors of fusion and brittleness, and the glue carrier is limited by the factors of viscosity and shaping. A conventional technology uses a high packing method to increase the content of the silica gel and the far-infrared powder to more than 50%. However, the PH value is too high by the far-infrared high packing method and will affect the vulcanization effect, so that the rubber cannot be made into the elastomer.

The conventional far-infrared product is concentrated on the hot effect and uses a heater to enhance the heating effect. However, the conventional far-infrared product ignores the non-hot effect. In fact, the far-infrared rays have prominent energy radiating effect. However, the conventional far-infrared product does employ the prominent energy radiating effect of the far-infrared rays.

On the other hand, the silica gel is used to function as the carrier of the far-infrared powder, and the high packing is used to increase the content of the far-infrared powder, so as to increase the coverage of the far-infrared powder, and to enhance the far-infrared radiation effect. The silica gel carrier of the conventional far-infrared product includes a colloid with 100 phr and a bridging agent with 0.5 phr. However, when the far-infrared powder has 100 phr, the vulcanization process is incomplete, so that the far-infrared powder and the carrier cannot be interconnected and ripened completely, and cannot be function as a far-infrared elastomer, such as an elastic dispatch.

Moreover, in the conventional far-infrared product, only the far-infrared powder of 5-10 phr is added into the carrier, and the content of the far-infrared powder is reduced, so that the energy radiating effect of the conventional far-infrared product is poor. In fact, the strength of the far-infrared rays depends on the irradiance (W/m²·um), not the emissivity. Thus, the more the content of the far-infrared powder, the stronger the irradiance (namely, the emission power), and the better the energy radiating effect of the far-infrared rays.

A method for making a conventional resilient silica gel dispatch includes abrading and mixing far-infrared mineral, ceramic powder and silica gel by a high pressure grinding machine, repeatedly adding sticky liquid and vulcanizing agent, successively grinding the sticky liquid and the vulcanizing agent at a high pressure to combine evenly the sticky liquid and the vulcanizing agent to form a mixture, performing a rolling operation on the mixture, and performing heating and press casting on the mixture until the mixture is hardened and molded into resilient silica gel sheet. In such a manner, the content of the far-infrared powder is about 50-65%, to increase the strength of irradiance. However, the content of the far-infrared powder does not reach the maximum coverage and cannot reach the optimum energy radiating effect. In addition, the far-infrared powder is added by a little amount at a time and is mixed repeatedly at many times, thereby complicating the working procedures and increasing the working time and cost.

### SUMMARY OF THE INVENTION

The primary objective of the present invention is to provide a far-infrared technology that enhances the far-infrared radiation strength.

In accordance with the present invention, there is provided a far-infrared elastomer comprising an elastic material and a far-infrared material. The elastic material has a weight proportion of 10-34.9%. The far-infrared material has a weight proportion of 65.1-90%. The far-infrared elastomer has a specific weight of 1.5-4.0 and a Shore hardness of 40-90 degrees.

In accordance with the present invention, there is further provided a method for manufacturing the far-infrared elastomer, comprising:

a step of preparing material including preparing a solid elastic material having a weight proportion of 10-34.9% and a powdered far-infrared material having a weight proportion of 65.1-90%;

a step of kneading including heating and mixing the solid elastic material and the powdered far-infrared material to form a mixture which ripens and produces an interconnection action;

a step of rolling including providing a hot rolling on the mixture to form a pre-shaped sheet plate with an even thickness; and a step of vulcanization including heating and vulcanizing the sheet plate to mold the sheet plate and form the far-infrared elastomer.

In accordance with the present invention, there is further provided a method for manufacturing the far-infrared elastomer, comprising:

a step of preparing material including preparing a liquid elastic material having a weight proportion of 10-34.9% and a powdered far-infrared material having a weight proportion of 65.1-90%;

a step of stirring and mixing including placing and stirring evenly the liquid elastic material and the powdered far-infrared material in a dipping container during 23-25 hours, so that the liquid elastic material and the powdered far-infrared material are mixed evenly to form a liquid mixture;

a step of dipping including dipping a reinforcing substrate in the dipping container to adhere the liquid mixture to the reinforcing substrate;

a step of drying including drying the liquid mixture and the reinforcing substrate to solidify the liquid mixture on the reinforcing substrate; and

a step of vulcanization including heating and vulcanizing the reinforcing substrate and the solidified liquid mixture by a vulcanizer, so that the solidified liquid mixture on the reinforcing substrate is molded into the far-infrared elastomer.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a product in accordance with the first preferred embodiment of the present invention.

FIG. 2 is a perspective view of a product in accordance with the second preferred embodiment of the present invention.

FIG. 3 is a cross-sectional view of the product in accordance with the second preferred embodiment of the present invention.

FIG. 4 is a schematic view showing fabrication of the product in accordance with the first preferred embodiment of the present invention.

FIG. 5 is a schematic view showing fabrication of the product in accordance with the second preferred embodiment of the present invention.

FIG. 6 is a flow chart of the method in accordance with the first preferred embodiment of the present invention.

FIG. 7 is a flow chart of the method in accordance with the second preferred embodiment of the present invention.

### DETAILED DESCRIPTION OF THE INVENTION

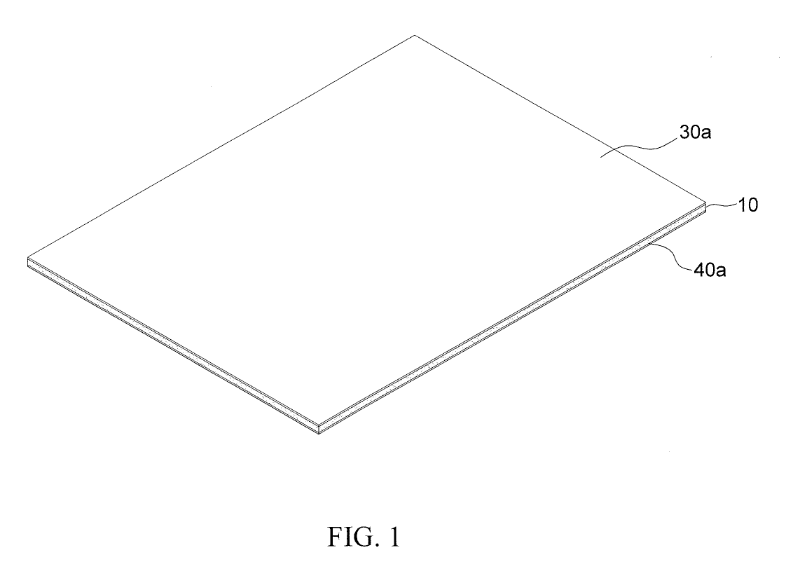

Referring to the drawings and initially to FIGS. 1-3, a far-infrared elastomer 10 in accordance with the preferred embodiment of the present invention comprises an elastic material and a far-infrared material. The elastic material is made of silica gel or rubber and has a weight proportion of 10-34.9%. The far-infrared material receives ambient heat radiation to produce far-infrared rays. The far-infrared material has a weight proportion of 65.1-90%. The far-infrared material has components including alumina (Al₂O₃), magnesium oxide (MgO), titanium dioxide (TiO₂), silicon dioxide (SiO₂), silicon carbide (SiC), silicon nitride (Si₃N₄), titanium nitride (TiN), volcanic rocks, a maifan stone (or medicinal stone), high temperature bamboo charcoal, prepared long charcoal or Guiyang stone. In the preferred embodiment of the present invention, the far-infrared elastomer 10 has a thickness of 0.2-3 mm, a specific weight of 1.5-4.0 and a Shore hardness of 40-90 degrees.

It is known from many years of research experiences that, the PH (potential of hydrogen) value of the far-infrared powder affects the vulcanization effect. Thus, the elastic material in the present invention includes a colloid (such as silica gel or rubber) with 90-110 phr (parts per hundreds of rubber or resin) (the optimum is 100 phr), a silane coupling agent with 3-8 phr (the optimum is 5 phr), and a low temperature bridging agent with 1.5-3.5 phr (the optimum is 2.5 phr). Thus, the carrier is molded into the far-infrared elastomer 10 having a high content. Preferably, the far-infrared elastomer 10 may in the form of a resilient patch that is bonded onto a human body.

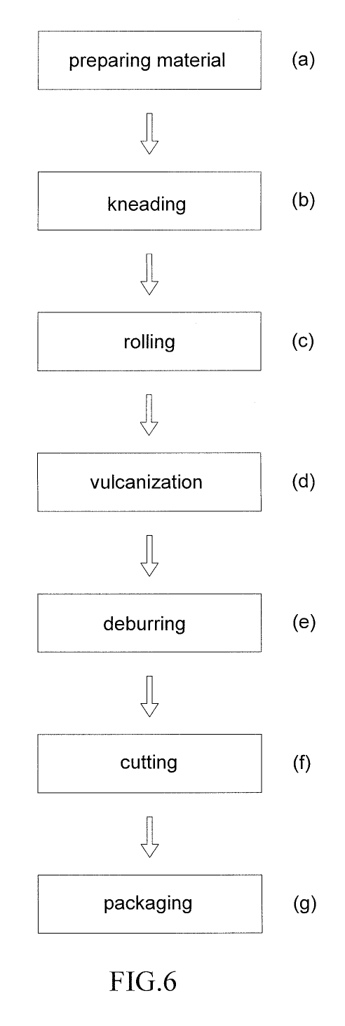

Referring to FIGS. 1, 4 and 6, a method for manufacturing the far-infrared elastomer 10 in accordance with the first preferred embodiment of the present invention comprises a first step (a) of preparing material, a second step (b) of kneading, a third step (c) of rolling, a fourth step (d) of vulcanization, a fifth step (e) of deburring, a sixth step (f) of cutting, and a seventh step (g) of packaging.

The first step (a) includes preparing a solid elastic material having a weight proportion of 10-34.9% and a powdered far-infrared material having a weight proportion of 65.1-90%, wherein the solid elastic material includes a colloid (such as silica gel or rubber) with 90-110 phr (parts per hundreds of rubber or resin) (the optimum is 100 phr), a silane coupling agent with 3-8 phr (the optimum is 5 phr), and a low temperature bridging agent with 1.5-3.5 phr (the optimum is 2.5 phr).

The second step (b) includes placing the solid elastic material and the powdered far-infrared material into a closed kneader which heats and mixes the solid elastic material and the powdered far-infrared material to form a mixture which ripens during 23-25 hours and produces an interconnection action.

The third step (c) includes providing a hot rolling on the mixture by a roll machine (such as open kneading rollers) at a heating temperature of 90-120 degrees Celsius, and then providing a hot calendering on the mixture by a roller set of an exporting machine at a heating temperature of 90-120 degrees Celsius, to form a pre-shaped sheet plate with an even thickness. In the third step (c), when the thickness of the sheet plate is smaller than 1 mm, a first reinforcing cloth layer 30a is mounted on a first face of the sheet plate, and a second reinforcing cloth layer 40a is mounted on a second face of the sheet plate as shown in FIGS. 1 and 4.

The fourth step (d) includes heating and vulcanizing the sheet plate by a vulcanizer to mold the sheet plate and form the far-infrared elastomer 10. In practice, the far-infrared elastomer 10 can be pressed to have a sheet form or molded to have a required lump shape. Preferably, the vulcanizer includes a vulcanizing tool of a steam tank type, a roller type and a molded type.

The fifth step (e) includes deburring the far-infrared elastomer 10 by a deburring machine or other working machine.

The sixth step (f) includes cutting the far-infrared elastomer 10 to have a predetermined shape by a cutter if the far-infrared elastomer 10 has a sheet form.

The seventh step (g) includes packaging the far-infrared elastomer 10 by a packaging machine.

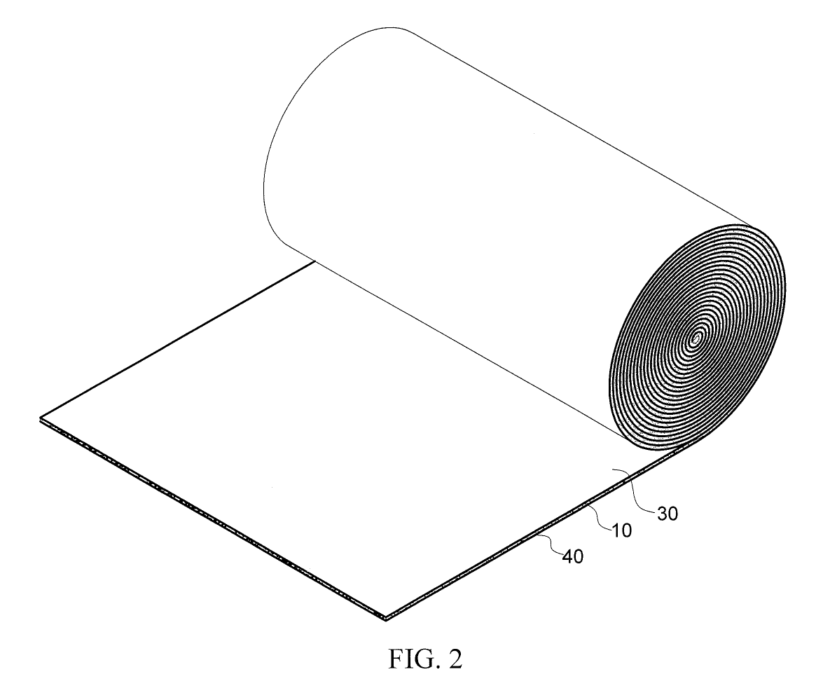

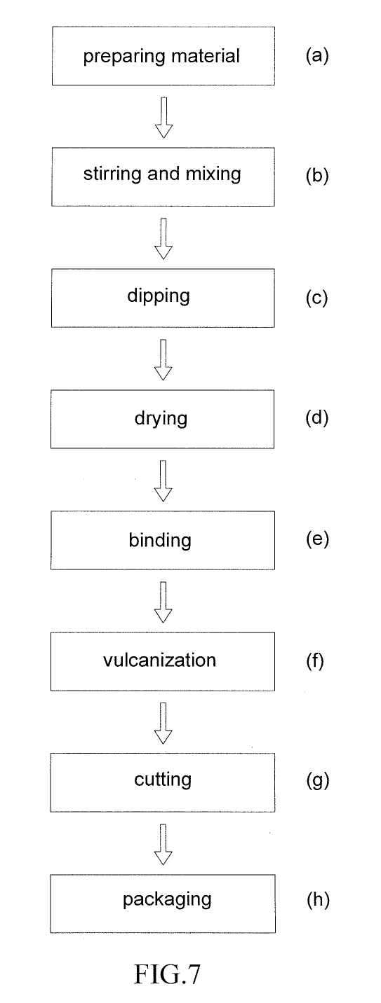

Referring to FIGS. 2, 3, 5 and 7, a method for manufacturing the far-infrared elastomer 10 in accordance with the second preferred embodiment of the present invention comprises a first step (a) of preparing material, a second step (b) of stirring and mixing, a third step (c) of dipping, a fourth step (d) of drying, a fifth step (e) of binding, a sixth step (f) of vulcanization, a seventh step (g) of cutting, and an eighth step (h) of packaging.

The first step (a) includes preparing a liquid elastic material having a weight proportion of 10-34.9% and a powdered far-infrared material having a weight proportion of 65.1-90%, wherein the liquid elastic material includes a colloid (such as silica gel or rubber) with 90-110 phr (parts per hundreds of rubber or resin) (the optimum is 100 phr), a silane coupling agent with 3-8 phr (the optimum is 5 phr), and a low temperature bridging agent with 1.5-3.5 phr (the optimum is 2.5 phr).

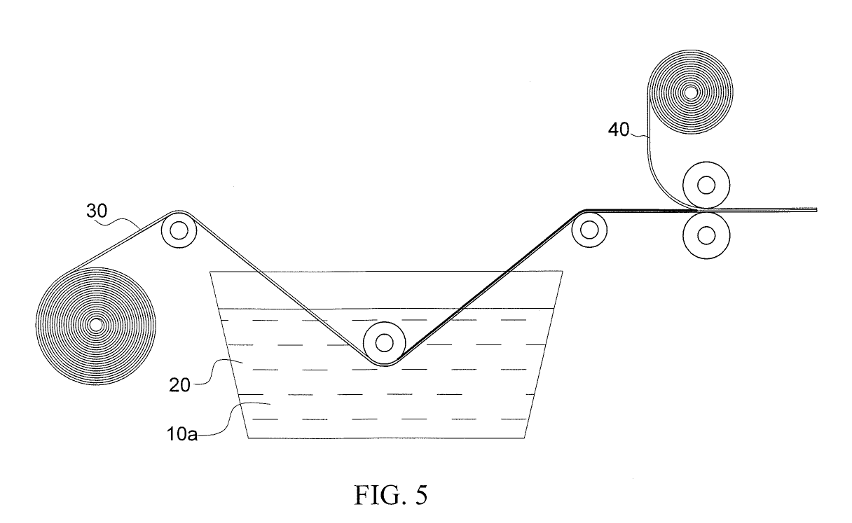

The second step (b) includes placing and stirring evenly the liquid elastic material and the powdered far-infrared material in a dipping container during 23-25 hours, so that the liquid elastic material and the powdered far-infrared material are mixed evenly to form a liquid mixture 10a as shown in FIG. 5.

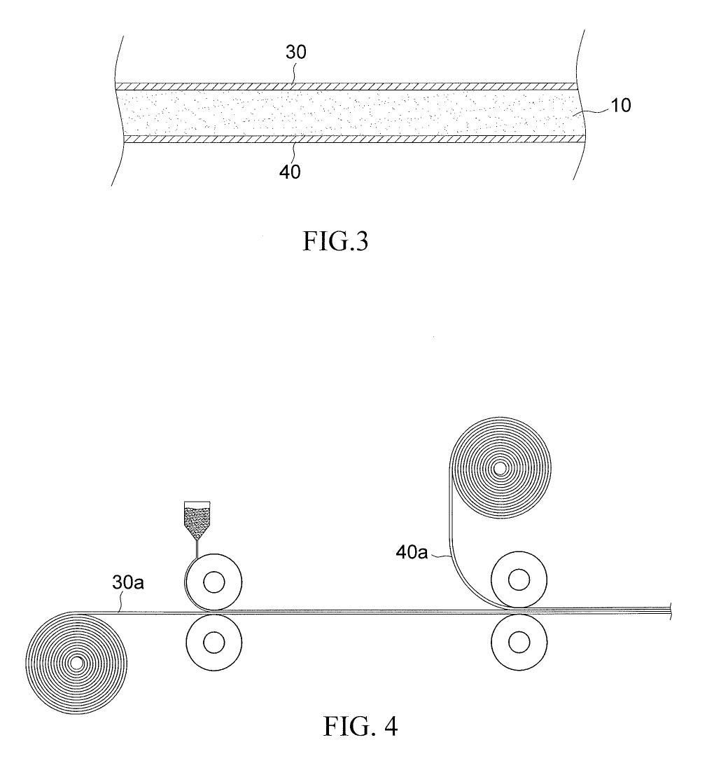

The third step (c) includes dipping a reinforcing substrate 30 (such as a bundle of reinforcing cloth material) in the dipping container 20 to adhere the liquid mixture 10a to the reinforcing substrate 30 as shown in FIG. 3.

The fourth step (d) includes drying the liquid mixture 10a and the reinforcing substrate 30 to solidify the liquid mixture 10a on the reinforcing substrate 30.

The fifth step (e) includes binding a bundle of cloth layer 40 on the solidified liquid mixture 10a by roller wrapping as shown in FIG. 3.

The sixth step (f) includes heating and vulcanizing the reinforcing substrate 30 and the solidified liquid mixture 10a by a vulcanizer, so that the solidified liquid mixture 10a on the reinforcing substrate 30 is molded into the far-infrared elastomer 10 as shown in FIG. 3. In practice, the far-infrared elastomer 10 can be pressed to have a sheet form or molded to have a required lump shape. Preferably, the vulcanizer includes a vulcanizing tool of a steam tank type, a roller type and a molded type.

The seventh step (g) includes cutting the far-infrared elastomer 10 to have a predetermined shape by a cutter if the far-infrared elastomer 10 has a sheet form.

The eighth step (h) includes packaging the far-infrared elastomer 10 by a packaging machine as shown in FIG. 2.

In addition, the far-infrared elastomer 10 in accordance with the present invention is tested by the Korean bureau, with an irradiance (namely, the emission power) reaching 3.55×10², and with an emissivity of 0.921. Thus, the irradiance of the far-infrared elastomer 10 in accordance with the present invention is greater than that of the far-infrared products of the market.

In the first experiment, the far-infrared powder of a weight of 125 grams is placed in a box with a volume of 23 cm×23 cm×23 cm. The distal end of the tester's finger is placed on the box during one hour. It is detected from the thermometer that, the temperature of the distal end of the tester's finger rises about 7 degrees Celsius.

In the second experiment, the far-infrared powder of a weight of 125 grams permeates a rubber plate with a volume of 51 cm×45 cm×0.3 cm. The distal end of the tester's finger is placed on the rubber plate during one hour. It is detected from the thermometer that, the temperature of the distal end of the tester's finger does not rise.

In the third experiment, the far-infrared powder of a weight of 125 grams permeates ten stacked rubber plates each having a volume of 51 cm×45 cm×0.3 cm. The distal end of the tester's finger is placed on the stacked rubber plates during one hour. It is detected from the thermometer that, the temperature of the distal end of the tester's finger rises about 6 degrees Celsius.

It is known from the above experiments that, when the density of the far-infrared powder is increased, the human health (including blood circulation and metabolism) is also enhanced. By the method of the present invention, the content of the far-infrared powder in the carrier has the optimum coverage, to enhance the irradiance of the far-infrared rays, and to enhance the radiation effect of the far-infrared rays, so that the far-infrared powder produces an outstanding energy irradiative effect under the heating state or under the normal temperature, to enhance the health protection effect of the human body.

Accordingly, the PH value of the far-infrared powder affects the vulcanization effect, so that the bridging agent needs to be increased to a determined proportion, and it is necessary to add the silane coupling agent, thereby forming the carrier into the far-infrared elastomer having a high content.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A far-infrared elastomer comprising an elastic material and a far-infrared material, wherein the elastic material has a weight proportion of 10-34.9%, the far-infrared material has a weight proportion of 65.1-90%, and the far-infrared elastomer has a specific weight of 1.5-4.0 and a hardness of 40-90 degrees.

2. The far-infrared elastomer in accordance with claim 1, wherein when the far-infrared elastomer is made into a sheet plate with a thickness of 0.2-3 mm.

3. The far-infrared elastomer in accordance with claim 1, wherein when the far-infrared elastomer is made into a sheet plate with a thickness smaller than 1 mm, a reinforcing cloth layer is mounted on at least one face of the sheet plate.

4. The far-infrared elastomer in accordance with claim 1, wherein the elastic material includes a colloid with 100 phr, a silane coupling agent with 5 phr, and a low temperature bridging agent with 2.5 phr.

5. A method for manufacturing the far-infrared elastomer in accordance with claim 1, comprising:
a step of preparing material including preparing a solid elastic material having a weight proportion of 10-34.9% and a powdered far-infrared material having a weight proportion of 65.1-90%;
a step of kneading including heating and mixing the solid elastic material and the powdered far-infrared material to form a mixture which ripens and produces an interconnection action;
a step of rolling including providing a hot rolling on the mixture to form a pre-shaped sheet plate with an even thickness; and
a step of vulcanization including heating and vulcanizing the sheet plate to mold the sheet plate and form the far-infrared elastomer.

6. The method in accordance with claim 5, wherein the far-infrared elastomer is made to have a sheet plate shape with a thickness of 0.2-3 mm.

7. The method in accordance with claim 5, wherein the far-infrared elastomer has a specific weight of 1.5-4.0 and a hardness of 40-90 degrees.

8. The method in accordance with claim 5, wherein the elastic material includes a colloid with 90-110 phr, a silane coupling agent with 3-8 phr and a low temperature bridging agent with 1.5-3.5 phr.

9. A method for manufacturing the far-infrared elastomer in accordance with claim 1, comprising:
a step of preparing material including preparing a liquid elastic material having a weight proportion of 10-34.9% and a powdered far-infrared material having a weight proportion of 65.1-90%;
a step of stirring and mixing including placing and stirring evenly the liquid elastic material and the powdered far-infrared material in a dipping container during 23-25 hours, so that the liquid elastic material and the powdered far-infrared material are mixed evenly to form a liquid mixture;
a step of dipping including dipping a reinforcing substrate in the dipping container to adhere the liquid mixture to the reinforcing substrate;
a step of drying including drying the liquid mixture and the reinforcing substrate to solidify the liquid mixture on the reinforcing substrate; and
a step of vulcanization including heating and vulcanizing the reinforcing substrate and the solidified liquid mixture by a vulcanizer, so that the solidified liquid mixture on the reinforcing substrate is molded into the far-infrared elastomer.

10. The method in accordance with claim 9, wherein the reinforcing substrate is a bundle of reinforcing cloth material.

11. The method in accordance with claim 9, wherein the far-infrared elastomer is made to have a sheet plate shape with a thickness of 0.2-3 mm.

12. The method in accordance with claim 9, wherein the far-infrared elastomer has a specific weight of 1.5-4.0 and a hardness of 40-90 degrees.

13. The method in accordance with claim 9, wherein the elastic material includes a colloid with 90-110 phr, a silane coupling agent with 3-8 phr and a low temperature bridging agent with 1.5-3.5 phr.
